(19) United States
(12) Patent Application Publication
(10) Pub. No.: US 2001/0046562 A1
(43) Pub. Date: Nov. 29, 2001

(54) Screen printable flame retardant coating

(76) Inventors: James Whitefield, Charlestown, RI (US); David Price, Mendon, MA (US); Miao-Yong Cao, Warwick, RI (US)

Correspondence Address: WEINGARTEN, SCHURGIN, GAGNEBIN, & HAYES, LLP, TEN POST OFFICE SQUARE, BOSTON, MA, 02109, US

(21) Appl. No.: 09/818,071

(22) Filed: Mar. 27, 2001

Related U.S. Application Data
(60) Provisional application No. 60/192,675, filed on Mar. 28, 2000.

(51) Int. Cl. C08J 9/00

(52) U.S. Cl. 427/372.2; 521/82; 521/92

(57) ABSTRACT

The instant invention relates to a coating, which can be applied to one or both sides of a flexible resin film, including flexible printed circuits made therefrom, in order to impart acceptable flammability characteristics to the material. The coating has the properties of being: (1) acceptable from the standpoint of improving the flammability rating to the product, (2) amenable to high speed production, in that it has a relatively fast curing rate, (3) directly applicable to the surface of the product and, in order to simplify the manufacturing process, it does not require pretreatment of the surface, and (4) acceptable from an aesthetics / appearance standpoint.

### CROSS REFERENCE TO RELATED APPLICATIONS

This application claims priority from U.S. Provisional Patent Application No. 60/192,675 filed Mar. 28, 2000, which is incorporated in its entirety herein.

### STATEMENT REGARDING FEDERALLY SPONSORED RESEARCH OR DEVELOPMENT

N/A

### BACKGROUND OF THE INVENTION

Frequently, components used in electronic, automotive, and other products are made, at least in part, of flammable materials, which are often materials of choice because of weight, cost, and other considerations. In order to make these materials more acceptable, it has been found that a flame retardant is needed. In the past, the flame retardant has generally been added to the plastic formulation so that it is imbedded within the plastic itself. For some applications, however, it is not possible or cost effective to incorporate the flame retardant within the product, and the resulting materials, with unacceptable flammability, were not usable in many applications.

Examples of such materials are polymer thick film (PTF) or copper flex circuits employing low cost films. PTF circuits are constructed by screen printing conductive tracks on a flexible resin film. Conventional flex circuits are constructed from copper foil laminated to polyimide and less often polyetherimide films. Both of these materials are costly. As a low cost alternative, polyester resin films such as polyethylene terephthalate (PET) are generally preferred. In addition to the PTF or copper conductive tracks, the majority of flex circuits employ a dielectric coating to provide electrical insulation and mechanical protection. Unfortunately, PET and many of these inks and coatings have poor flammability characteristics making them unacceptable for applications, such as automotive interiors, where low flammability is required.

U.S. Pat. No. 4,136,225 is directed to a flame retardant cover layer for flexible printed circuits using a halogenated monomer. The cover layer is cured by UV radiation. U.S. Pat No. 4,311,749 is directed to the manufacture of a flexible printed circuit, which includes a flexible resin film and copper foil conductors using a combination of flame proof coatings and laminating adhesives. The flexible resin film requires a treatment to modify surface tension for proper adhesion of the coatings and adhesives. U.S. Pat. No. 4,933,233 is directed to a flame proof anti static cover film using a halogenated monomer cured by electron beam radiation. U.S. Pat. No. 5,229,192 teaches the manufacture of a flexible printed circuit using a cover film bonded with a non-flowing flameproof adhesive.

### BRIEF SUMMARY OF THE INVENTION

The instant invention relates to a coating, which can be applied to one or both sides of a flexible resin film, including flexible printed circuits made therefrom, in order to impart acceptable flammability characteristics to the material. The coating has the properties of being: (1) acceptable from the standpoint of improving the flammability rating to the product, (2) amenable to high speed production, in that it has a relatively fast curing rate, (3) directly applicable to the surface of the product and, in order to simplify the manufacturing process, it does not require pretreatment of the surface,, and (4) acceptable from an aesthetics/appearance standpoint.

### DETAILED DESCRIPTION OF THE INVENTION

Traditionally, when an otherwise flammable substrate is required to meet specific flammability requirements, flame retardant additives are compounded in the substrate resin during the substrate manufacturing process. Already manufactured flammable substrates, such as polyester (PET), cannot be used in many applications that have flammability requirements. As a result of the instant invention, certain applications, for example, the use of standard substrates for manufacturing circuits for automobiles and other products with flammability requirements, are possible.

The instant invention is applicable to many flammable film substrates, including polyester, polyurethane, nylon or paper and flexible printed circuits constructed therefrom. A flexible printed circuit consists of a flexible film substrate with conductive tracks on one or both sides of the film. The circuit also employs the coating of the current invention on one or both sides of the film to provide flame resistance and electrical or mechanical protection. The conductive tracks can be formed by printing PTF conductive inks utilizing conductive particles such as silver, copper, gold and carbon or graphite. Alternatively, the conductive tracks can be solid metal conductors formed by laminating and/or etching from metals such as copper or aluminum.

The coatings of the current invention have a number of attributes.

1. The coating is screen printable, which means that it can be applied to only the areas desired and application to these areas is sufficient to impart the flame resistance. In addition, it can be printed at rates exceeding 1500 impressions per hour, which is compatible with high volume manufacturing. While the screen coating techniques in general are known, conventional screen-printed coatings for flexible circuits do not improve the flammability performance of the substrate.

2. The coating is cured in less than two minutes, which is compatible with high volume manufacturing.

3. The coating has a unique formulation of flame-retardant additives used for flexible electronic circuits, in that it combines halogenated organic compounds, inorganic antimony compounds and a metal hydroxide.

4. One of the main benefits resulting from using this coating is that it does not require commercially pretreated substrates or the use of a surface tension modification step such as corona treatment prior to printing. For example, prior to this invention, in order to use PET as a substrate, in many cases it was necessary to pretreat the substrate using a corona treatment or to apply a chemical pretreatment in order for coatings to properly adhere to the substrate. The novel coating provides excellent adhesion to non-treated substrates and PTF conductor inks. The coating demonstrates 100% or 5B adhesion to these surfaces when tested in accordance with ASTM test procedure D3359 method B.

5. The coatings invented herein are excellent from the standpoint of flame retardancy. For example, one coating in this patent application was developed for a vanity mirror light circuit so that in addition to functioning as a dielectric coating it also must provide acceptable flammability. The specification for flammability of automotive interior components is set by the U.S. National Highway Traffic Safety Administration (NHTSA) in 49 CFR 571.302 (also referred to as Federal Motor Vehicle Safety Standard (FMVSS) 302).

### Composition of Flame-retardant Coating

The formulation of the coating is as follows (note that the weight units are arbitrary weight units):

TABLE 1

| | Weight | Approx. | Preferred |
|---|---|---|---|
| Component | Range | % range | % range |
| Polymer | 5-15 | 6-34 | 7-20 |
| Solvents | 25-45 | 31-85 | 32-60 |
| Flame retardants | 3-40 | 4-57 | 6-45 |
| Coupling agent | 0.1-0.5 | <1 | 0.15-0.3 |
| Leveling agent | 0.1-0.25 | <1 | 0.1-0.2 |
| Surfactant | 0.01-0.15 | <1 | 0.01-0.15 |

In addition to the above components, optional ingredients are possible. For example, those that impact the appearance of the film, such as titanium dioxide or other colored pigments and an optical brightener, can be added. In place of or in addition to the colored pigments, inert fillers such as talc, silica, kaolin, calcium carbonate or barium sulfate may be added. Typical amounts of these components are shown below. (These are shown in the same arbitrary weight units used above. When these items are used in the formulation, the percentages of the above ingredients are obviously decreased.)

TABLE 2

| | | Approx. | Preferred |
|---|---|---|---|
| Optional component | Weight range | % range | Weight |
| Pigment or filler | 20-30 | 16-48 | 25 |
| Optical brightener | 0.05-0.2 | 0.04-0.4 | 0.1 |

Since the composition is applied to the surface of the component, the appearance of the film deposited may be critical. For example, using Titanium Dioxide in the formula as a base, the coating can be tinted to any color desired by the addition of the appropriate pigment.

It should be noted that several sequential printed layers can be applied to the same substrate, with a drying step following application of each layer. The flame-retardant coating can be applied to either the same or opposite side as that containing the conductive inks, or it can be applied to both sides of the substrate.

In the above formulation, there are numerous chemicals that can be utilized for each component. For example, the polymer can be a vinyl polymer such as UCAR® Solution Vinyl resins manufactured by Union Carbide (for example UCAR® VAGF, a co-polymer of vinyl chloride, vinyl acetate and hydroxyalkyl acrylate). Other possible resins are thermoplastic phenoxy, polyester, acrylic or polyurethane resins. Thermosetting resin formulations may also be used such as amino resin or isocyanate cross-linked epoxy, phenoxy, polyester or vinyl resins. Note that some of these polymers are dissolved in solvents before they are used to coat the substrate. For example, UCARO VAGF can be dissolved in δ Butyrolactone or other suitable solvent for ease of application.

The solvent, which affects viscosity of the solution, the ease of printing and the speed of drying, can be glycol ethers or glycol ether acetates such as diethyleneglycol monobutylether (butyl carbitol) and diethyleneglcol monoethylether acetate (carbitol acetate), dibasic esters such as dimethyl adipate, dimethyl succinate or dimethyl glutarate, gamma butyrolactone or mixtures thereof. In the case of thermosetting resin formulations, the solvent may be completely or partially replaced with a reactive diluent, such as low viscosity glycols (for example, diethylene, triethylene, dipropylene or tripropylene glycol), polyglycols (for example, polyethylene or polypropylene glycol) and polyester polyols (for example, Tone® polyols available from Union Carbide).

The flame-retardant additives can include a single component or a mixture of ingredients. Several possibilities include halogenated organic compounds (for example ethylenebistetrabromophthalimide, which is available as Albemarle Corporation's Saytex® BT93W, or decabromodiphenyl oxide, which is available as Saytex® 102E), inorganic antimony compounds, and a metal hydroxide (such as Lonza/Alusuisse Martinal OL104/LE Aluminum Hydroxide). A preferred formulation contains a mixture of halogenated flame retardant and antimony oxide (either the trioxide or the pentoxide or a mixture of both), and 20 parts aluminum hydroxide. The halogenated organic and antimony oxide are combined at a ratio of 2-3 parts halogenated organic to 1 part antimony oxide, and the ratio of these components to the aluminum hydroxide is determined by the target decomposition temperature. The decomposition temperature of the additive and subsequent release of flame suppressing gases must be close to the decomposition/combustion temperature of the substrate. The choice of the halogenated additive is governed by the substrate.

The leveling agent and surfactant are flow control additives, which contribute to the wetting of the substrate and the leveling of the coating surface. The coupling agent promotes intimate contact between dissimilar materials, such as the resin and the insoluble flame-retardant powders and pigments. The result is improved mixing, lower viscosity and better dispersion of the flame-retardant additives. In some cases, one ingredient (e.g., a surfactant) may perform several of the effects attributed to the leveling agent, surfactant and coupling agent. Also, one or more of the major ingredients (e.g., solvent or polymer) might provide the performance attribute normally provided by these minor ingredients.

Typical coupling agents are organotitanates or organozirconates such as Kenrich Petrochemical's Lica® 38, which is neopentyl (diallyl) oxy tri (dioctyl) pyrophosphato titanate.

Typical leveling agents are modified silicone oils such as BYK Chemie's BYK® 323 or non-silicone polyacrylate leveling agents such as Modaflow® manufactured by Solutia. Typical surfactants are fluorocarbons such as FC430 manufactured by 3M or silicone materials such as BYK® 307.

### The following examples are presented to illustrate, not limit the invention.

### EXAMPLE 1

### Manufacture of the Coating

A coating was prepared using the following ingredients.

TABLE 3

| | Approx. |
|---|---|
| Component | Weight % |
| Resin Solution | 37.79 |
| (UCAR ® VAGF 25% in δ Butyrolactone) | |
| Solvent | 10.0 |
| (Diethyleneglycolmonoethylether acetate) | |
| Flame Retardant 1 | 4.5 |
| (SAYTEX ® BT93W) | |
| Flame Retardant 2 | 2.25 |
| (Antimony Oxide Sb203) | |
| Flame Retardant 3 | 20.0 |
| (Aluminum Hydroxide) | |
| Pigment | 25.0 |
| (TiO2 DuPont TIPURE ® R-706) | |
| Optical Brightener | 0.1 |
| (Ciba Specialty chemicals | |
| UVITEX ® OB) | |
| Surfactant | 0.05 |
| (3M Fluorocarbon FC 430) | |
| Leveling Agent | 0.1 |
| (BYK Chemie BYK ® 323) | |
| Coupling Agent | 0.21 |
| (Kenrich Petrochemical Lica ® 38) | |

Note that the resin solution contained 25% of UCAR VAGF. Thus the total amount of resin was about 9.45%, and the total amount of solvent was 28.34 plus 10 percent, for a total of 38.34% solvent. (If this system did not contain pigment, the percentages of resin, solvent, and flame retardant would be approximately 15.3, 57.6 and 26.8, respectively.)

The resin solution, solvents, coupling agent and optical brightener are placed in a mixing vessel and mixed to combine. To the stirring solution, the solid ingredients (aluminum hydroxide, BT93W, Sb₂O₃ and TiO₂) are added in sequence. The mixture is stirred for the appropriate time (approximately 30 min.), the surfactant and leveling agent are added, and the mixture stirred for a further 10 minutes.

### EXAMPLE 2

### Application of the Coating

The coating of example 1 was applied to a PTF circuit on 0.13 mm thick untreated PET film through a patterned 165 mesh stainless steel screen using standard screen printing technology.

The screen mesh was selected to produce a dry ink film thickness (DIFT) of between 13 and 20 microns, 16-18 microns being the typical DIFT. Stainless steel or polymer mesh screens are acceptable. The applied coating was cured in a conveyor oven at 120° C. for 60 seconds.

### EXAMPLE 3

### Testing the Substrate with Coating Applied

The resulting cured coating had adhesion of 100% or 5B to both the substrate and the conductive tracks when tested in accordance with ASTM D3359 method B and a pencil hardness of 4H when tested in accordance with ASTM D3363.

Five replicates of the above flex circuit having dimensions 154 mm×96 mm×0.17 mm were tested using FMVSS 302. All were found to have Burn Type SE (part does not burn beyond first timer mark).

### EXAMPLE 4

### Method of Making a Circuit Board having Flame Retardant Coating Printed Thereon

Conductive tracks were formed on one side of a 0.13 mm thick untreated PET polyester film using a silver filled conductive ink applied through a patterned 230 mesh stainless steel screen. The conductive ink was cured in a conveyor oven at 120° C. for 60 seconds. An additional set of conductive tracks were formed on the same side of the film using a conductive ink filled with a carbon/graphite blend through a through a patterned 230 mesh stainless steel screen. The second conductive ink was cured in a conveyor oven at 120° C. for 60 seconds. The flame retardant coating of example 1 was printed both (1) over the conductive tracks and (2) on the side of the film opposite the conductive tracks, through a patterned 165 mesh stainless steel screen and cured in a conveyor oven at 120° C. for 60 seconds.

Those with expertise in this area will recognize further variations of the invention, which are consistent with the disclosure herein.

1. A screen printable flame retardant coating composition comprising approximately 6-34% polymer, 31-85% solvents, 4-57% flame retardant additives, and less than 1% each of coupling agent, leveling agent and surfactant.

2. The coating composition of claim 1 wherein said flame retardant additives are one or more products selected from the group consisting of halogenated organic compounds, inorganic antimony compounds, and metal hydroxides.

3. The coating composition of claim 2 wherein said flame retardant additives are ethylenebistetrabromophthalimide, antimony oxide and aluminum hydroxide.

4. The coating composition of claim 1 wherein said polymer is selected from the group consisting of thermoplastic vinyl, polyester, polyurethane, acrylic or phenoxy resins.

5. The coating composition of claim 1 wherein said polymer is a thermosetting resin selected from the group consisting of amino resin, isocyanate cross-linked phenoxy, epoxy, polyester and vinyl resins.

6. The coating composition of claim 1 wherein said solvents are one or more products selected from the group consisting of glycol ethers, glycol ether acetates, dibasic esters, gamma butyrolactone and reactive diluents or mixtures thereof.

7. The coating composition of claim 1 comprising approximately 15.3% polymer, 57.6% solvents, and 26.8% flame retardant additives.

8. The coating composition of claim 1 which also optionally comprises (1) a colorant or inert filler and (2) an optical brightener.

9. The coating composition of claim 8 wherein said colorant or filler is present at approximately 16-48% by weight of said composition and said brightener is present at approximately 0.04-0.4% of said composition.

10. The coating composition of claim 1, wherein the substrate film does not require pretreatment to promote adhesion of said coating.

11. A flexible printed circuit comprising (a) a flexible substrate, (b) conductive tracks adhered to one or both surfaces of said flexible substrate, and (c) the flame retardant coating of claim 1 applied to one or both surfaces of said flexible substrate.

12. The flexible printed circuit of claim 11 wherein said substrate is selected from a group consisting of polyester, polyurethane, nylon or paper.

13. The flexible printed circuit of claim 11 wherein said conductive tracks are polymer thick film inks.

14. The flexible circuit of claim 13 wherein said conductive tracks are inks comprising conductive particles selected from a group consisting of silver, copper, gold, carbon or graphite.

15. The flexible printed circuit of claim 11 wherein said conductive tracks are solid metal conductors selected from the group consisting of copper or aluminum.

16. The flexible printed circuit of claim 11 wherein said substrate is polyethylene terephthalate film.

17. The flexible printed circuit of claim 11 wherein said conductive tracks comprise sequentially printed layers of
a. conductive tracks of silver filled PTF ink and
b. conductive tracks of carbon/graphite filled PTF ink.

18. The flexible printed circuit of claim 17 further comprising the flame-retardant coating of claim 1 printed on the film face opposite the conductive tracks.

19. A process for imparting flame retardancy to a previously flammable substrate, comprising applying a flame retardant coating to said flammable substrate and heating to dry said coating.

20. The process of claim 19 wherein said flame retardant coating is the coating of claim 1.
